(19) United States
(12) Patent Application Publication
(10) Pub. No.: US 2012/0252351 A1
(43) Pub. Date: Oct. 4, 2012

(54) SATELLITE RECEIVER, SATELLITE BROADCAST RECEIVING METHOD, AND PROGRAM

(75) Inventor: Yoshikazu Yoshida, Tokyo (JP)

(73) Assignee: SONY CORPORATION, Tokyo (JP)

(21) Appl. No.: 13/419,872

(22) Filed: Mar. 14, 2012

(30) Foreign Application Priority Data
Mar. 29, 2011 (JP) 2011-071542

(51) Int. Cl. H04H 20/74

(52) U.S. Cl. 455/3.02

(57) ABSTRACT

A satellite receiver includes a control unit adapted to output to an antenna control signals for time-sequentially switching between a plurality of different satellite broadcast signals, a channel selecting unit adapted to select a transponder including a specific program from each of a plurality of broadcast signals input from the antenna, and a demultiplexer adapted to extract specific program data from each of the plurality of transponders selected by the channel selecting unit.

### CROSS-REFERENCE TO RELATED APPLICATION

The present application claims priority from Japanese Patent Application No. JP 2011-071542, filed in the Japanese Patent Office on Mar. 29, 2011, the entire content of which is incorporated herein by reference.

### BACKGROUND

The present disclosure relates to a satellite receiver, a satellite broadcast receiving method, and a program. It relates in particular to a satellite receiver, satellite broadcast receiving method, and program that enable the reception of a plurality of programs.

Nowadays, some television programs are broadcast via satellites.

Signals transmitted via satellites are received by an antenna (satellite dish) installed at each home, for example, from which a channel is selected and output by a tuner to a television receiver or the like.

At present, in a satellite broadcasting system in Japan, for example, a plurality of satellites are used to broadcast a large number of contents (programs) corresponding to a large number of channels using different signal formats including vertically polarized signals and horizontally polarized signals.

The antenna at each home, in response to control signals input from the tuner on the basis of the program selection information input by the user to the tuner, controls reception settings to enable the reception of a broadcast wave from the satellite currently transmitting the selected program in a specific signal format, selectively receives the broadcast wave containing the program selected by the user, and outputs the received signal from the antenna to the tuner.

In this manner, a single program is selected from a plurality of programs transmitted from a plurality of satellites and is displayed on a television screen.

Satellite broadcasting systems are disclosed in Japanese Unexamined Patent Application Publication Nos. 2000-68952 and 2000-13762, for example.

Although the antenna can receive different signals including vertically polarized signals and horizontally polarized signals transmitted from a plurality of satellites as described above, only one of them is output from the antenna to the tuner.

In a configuration with two satellites, i.e., first and second satellites, each transmitting a vertically polarized signal and a horizontally polarized signal, the antenna can receive the following four signals:
(1) vertically polarized signal from the first satellite (1V),
(2) horizontally polarized signal from the first satellite (1H),
(3) vertically polarized signal from the second satellite (2V), and
(4) horizontally polarized signal from the second satellite (2H).

The antenna installed at each home can receive these four signals. Of these four signals, only one signal containing the program selected by the user can be output from the antenna to a tuner.

The tuner changes the reception settings in the antenna by outputting to the antenna a control signal for causing the antenna to receive only the signal containing the program selected by the user.

More specifically, the antenna distinguishes the four signals on the basis of the DC levels and the presence/absence of a superimposed modulating signal, for example, and selectively receives and outputs only one of the four signals to the tuner.

These settings do not allow the tuner to receive two different contents (programs) at the same time to view one program on a television screen and record the other program, for example.

### SUMMARY

It is desirable to provide a satellite receiver, satellite broadcast receiving method, and program enabling the reception of a plurality of satellite broadcast signals.

An embodiment of the present disclosure provides a satellite receiver including a control unit adapted to output to an antenna control signals for time-sequentially switching between a plurality of different satellite broadcast signals, a channel selecting unit adapted to select transponders each including a specific program from a plurality of broadcast signals input from the antenna, and a demultiplexer adapted to extract specific program data from the transponders selected by the channel selecting unit.

In this embodiment of the present disclosure, the control unit, in response to a plurality of program selection information input via an input unit, may output to the antenna control signals for enabling the reception of the selected programs.

In this embodiment of the present disclosure, the control unit may output to the antenna at least one of a control signal for switching between satellite broadcast signals coming from a plurality of different satellites and a control signal for switching between a vertically polarized signal and a horizontally polarized signal coming from the same satellite.

In this embodiment of the present disclosure, the channel selecting unit may select transponders each including the specific program during the reception periods allocated to the broadcast signals input from the antenna, select a first transponder including a first program from the signal being received during the reception periods allocated to the first broadcast signal, and select a second transponder including a second program from the signal being received during the reception periods allocated to the second broadcast signal.

In this embodiment of the present disclosure, the demultiplexer may extract data including a first program from the first transponder selected by the channel selecting unit from the signal being received during the reception periods allocated to the first broadcast signal, and extract data including a second program from the second transponder selected by the channel selecting unit from the signal being received during the reception period allocated to the second broadcast signal.

In this embodiment of the present disclosure, the satellite receiver may further include a signal processing unit for performing signal processing on the program data extracted by the demultiplexer.

In this embodiment of the present disclosure, the control unit may, on the basis of the synchronizing signals set in the broadcast signals, generate and output to the antenna control signals in which reception periods of the broadcast signals are set.

Another embodiment of the present disclosure provides a satellite broadcast receiving method to be practiced in a satellite receiver, the method including outputting from a control unit to an antenna control signals for time-sequentially switching between a plurality of different satellite broadcast signals, selecting in a channel selecting unit a transponder including a specific program from each of a plurality of broadcast signals input from the antenna, and extracting in a demultiplexer specific program data from each of the plurality of transponders selected by the channel selecting unit.

Still another embodiment of the present disclosure provides a program for causing a satellite broadcast receiving process to be performed in a satellite receiver, the program including causing a control unit to output to an antenna control signals for time-sequentially switching between a plurality of different satellite broadcast signals, causing a channel selecting unit to select a transponder including a specific program from each of a plurality of broadcast signals input from the antenna, and causing a demultiplexer to extract a specific program data from each of the plurality of transponders selected by the channel selecting unit.

The program according to this embodiment of the present disclosure can be provided in the form of a computer-readable recording medium or through a communication medium to information processors and/or computer systems capable of executing various program codes, for example. When such a program is provided in a computer-readable format, processing is performed according to the program on the information processors and/or computer systems.

Other purposes, features, and advantages of the present disclosure will be apparent from the later-described embodiments of the present disclosure and the detailed description with reference to the appended drawings. In this specification, the system is a logical aggregate configuration of a plurality of devices that are not necessarily accommodated in a single housing.

According to a configuration in an embodiment of the present disclosure, a satellite receiver and satellite broadcast receiving method enabling the reception of two satellite broadcast programs are implemented.

More specifically, a control unit outputs to an antenna control signals for time-sequentially switching between a plurality of different satellite broadcast signals, a channel selecting unit selects transponders each including a specific program from the plurality of broadcast signals input from the antenna, and a demultiplexer extracts specific program data from the plurality of transponders selected by the channel selecting unit, for example. This enables a first program included in a vertically polarized signal output from a first satellite and a second program included in a horizontally polarized signal output from a second satellite to be received on a time-division basis to output one program to a television receiver and record the other program, for example.

### BRIEF DESCRIPTION OF THE DRAWINGS

FIG. 1 illustrates a general configuration of a satellite broadcast receiving system;

FIG. 2 illustrates an exemplary configuration of satellite broadcast signals;

FIG. 3 illustrates an exemplary configuration of a satellite receiver;

FIG. 4 illustrates an exemplary configuration of an antenna for receiving a satellite broadcast;

FIG. 5 illustrates an exemplary configuration of a tuner and exemplary processing for receiving a satellite broadcast;

FIG. 6 illustrates an exemplary configuration of a satellite receiver according to an embodiment of the present disclosure;

FIGS. 7A and 7B illustrate exemplary satellite broadcast receiving processes;

FIG. 8 illustrates an exemplary satellite broadcast receiving process;

FIG. 9 illustrates an exemplary satellite broadcast receiving process;

FIG. 10 illustrates an exemplary satellite broadcast receiving process;

FIG. 11 illustrates an exemplary configuration of a satellite receiver; and

FIG. 12 illustrates exemplary configurations of broadcast signals having synchronizing signals.

### DETAILED DESCRIPTION OF EMBODIMENTS

A satellite receiver, satellite broadcast receiving method, and program according to an embodiment of the present disclosure will now be described in detail with reference to the drawings. The description will be given in the following order:
1. Overview of a satellite broadcasting system
2. Satellite broadcast receiving configuration enabling the reception of a plurality of programs
3. Exemplary configuration of a satellite receiver
4. Exemplary broadcast signals having synchronizing signals
5. Overview of embodiments of the present disclosure

### [1. Overview of a Satellite Broadcasting System]

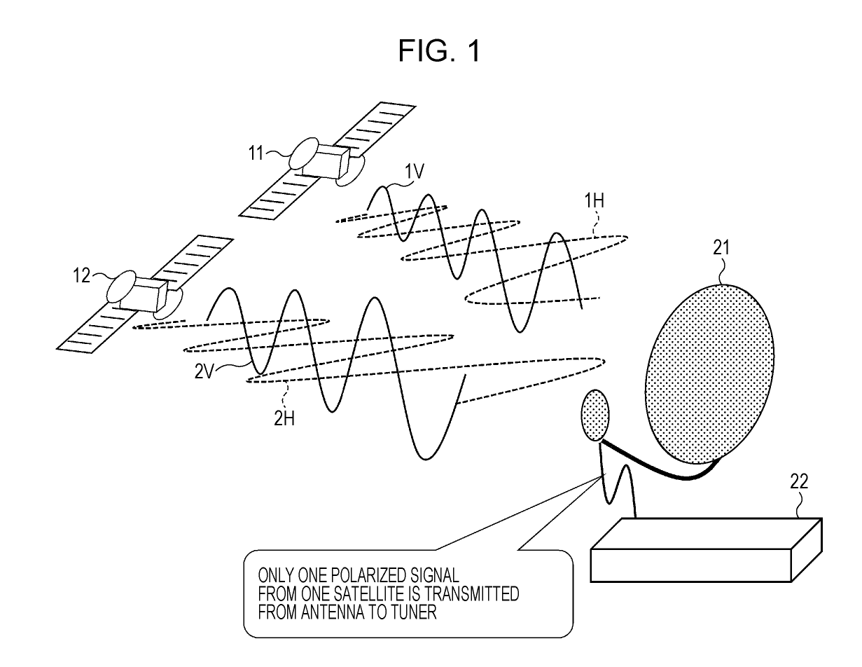

Referring first to FIG. 1 and following drawings, a typical satellite broadcasting system will be outlined.

FIG. 1 shows two satellites outputting TV broadcasting signals, an antenna 21 installed at home, for example, to receive TV broadcasting signals, and a tuner 22 for inputting a signal received by the antenna and generating an output signal to be output to a television receiver or the like.

The first satellite 11 and second satellite 12 shown in FIG. 1 each output two different signals, i.e., a vertically polarized signal and a horizontally polarized signal in parallel as shown in FIG. 1.

The antenna 21 installed at each home can therefore receive the following four signals:
(1) vertically polarized signal from the first satellite (1V),
(2) horizontally polarized signal from the first satellite (1H),
(3) vertically polarized signal from the second satellite (2V), and
(4) horizontally polarized signal from the second satellite (2H).

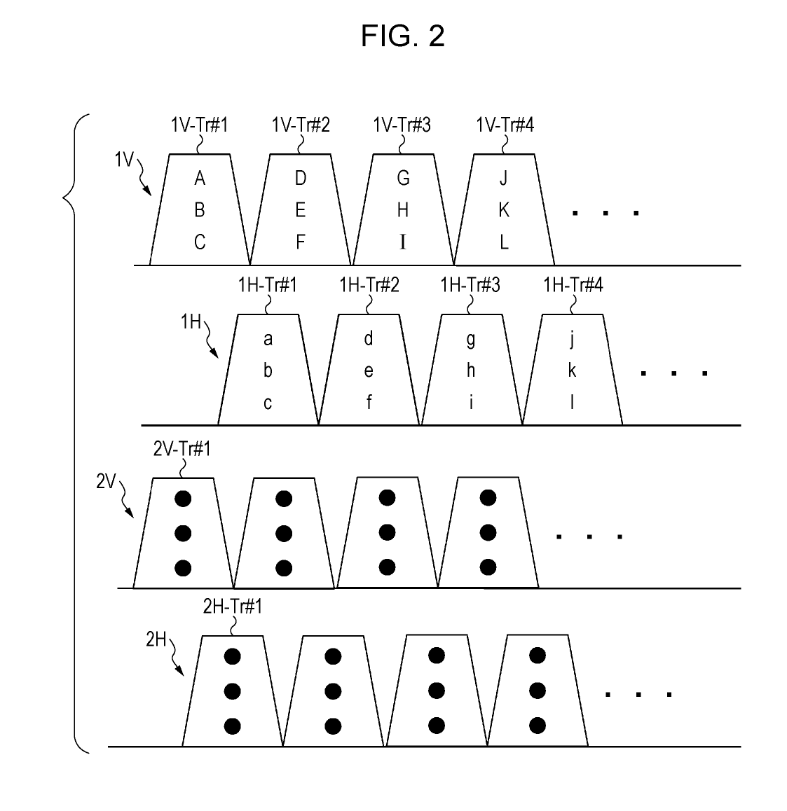

These four signals include contents (programs) corresponding to different channels. Referring now to FIG. 2, a specific example will be described.

FIG. 2 shows an example of specific settings of the above four signals:
(1) vertically polarized signal from the first satellite (1V),
(2) horizontally polarized signal from the first satellite (1H),
(3) vertically polarized signal from the second satellite (2V), and
(4) horizontally polarized signal from the second satellite (2H).

For example, the signal (1V) shown in FIG. 2 represents a configuration of the vertically polarized signal from the first satellite (1V).

The vertically polarized signal from the first satellite (1V) is configured of a plurality of transponders (Tr# n).

One transponder includes a plurality of program contents. Each of A, B, C . . . , a, b, c, . . . shown in FIG. 2 corresponds to a user-selectable program (channel). The user can select these programs one at a time.

The vertically polarized signal from the first satellite (1V) includes the following transponders:
transponder (Tr#1) including programs A-C,
transponder (Tr#2) including programs D-F,
transponder (Tr#3) including programs G-I,

and so on.

Similarly, the horizontally polarized signal from the first satellite (1H) includes the following transponders:
transponder (Tr#1) including programs a-c,
transponder (Tr#2) including programs d-f,
transponder (Tr#3) including programs g-i,

and so on.

In each of the remaining signals, a plurality of transponders including a plurality of programs are set.

The user can select the programs included in the transponders one at a time.

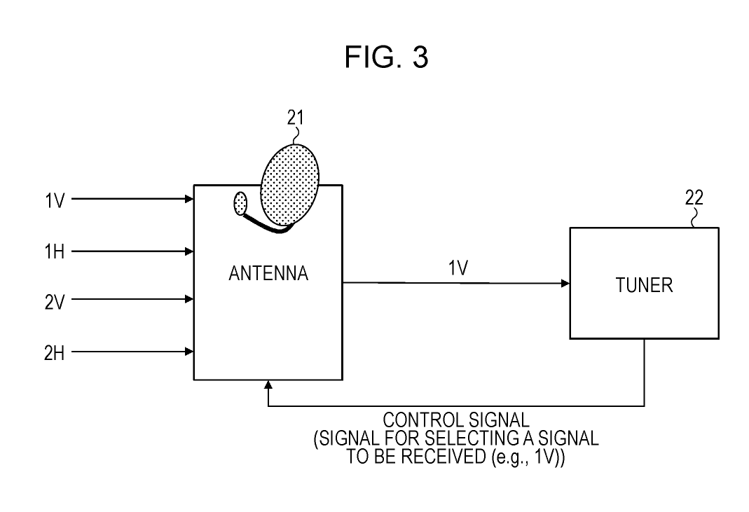

Referring now to FIG. 3, a specific case in which the user selects to view a “program A” via the input unit in the tuner 22 will be described.

When the user selects to view the “program A” via the input unit in the tuner 22, the tuner 22 outputs to the antenna 21 a control signal for enabling the reception of the vertically polarized signal from the first satellite (1V), as shown in FIG. 3.

In response to this control signal, the antenna 21 controls and adjusts reception settings to receive only the vertically polarized signal from the first satellite (1V).

As a result, the antenna 21 receives and outputs only the vertically polarized signal from the first satellite (1V) to the tuner 22.

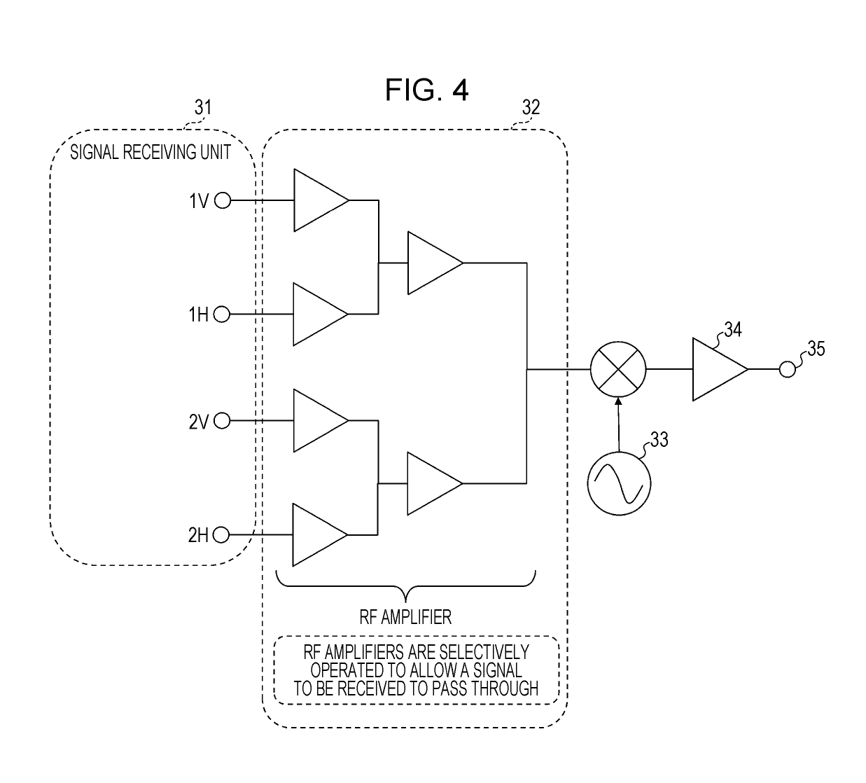

As shown in FIG. 4 for example, the antenna 21 has a signal receiving unit 31 for receiving the following signals:
(1) vertically polarized signal from the first satellite (1V);
(2) horizontally polarized signal from the first satellite (1H);
(3) vertically polarized signal from the second satellite (2V); and
(4) horizontally polarized signal from the second satellite (2H),
an RF amplifier unit 32 for allowing these signals to path through, a local oscillator 33, an IF amplifier 34, and an output unit 35.

In response to the control signal input from the tuner 22 on the basis of the selected program, the RF amplifier unit 32 selectively operates to enable only one signal to pass through. This selection operation causes only one signal of the above four signals (1)-(4) to be input through the output unit 35 to the tuner 22.

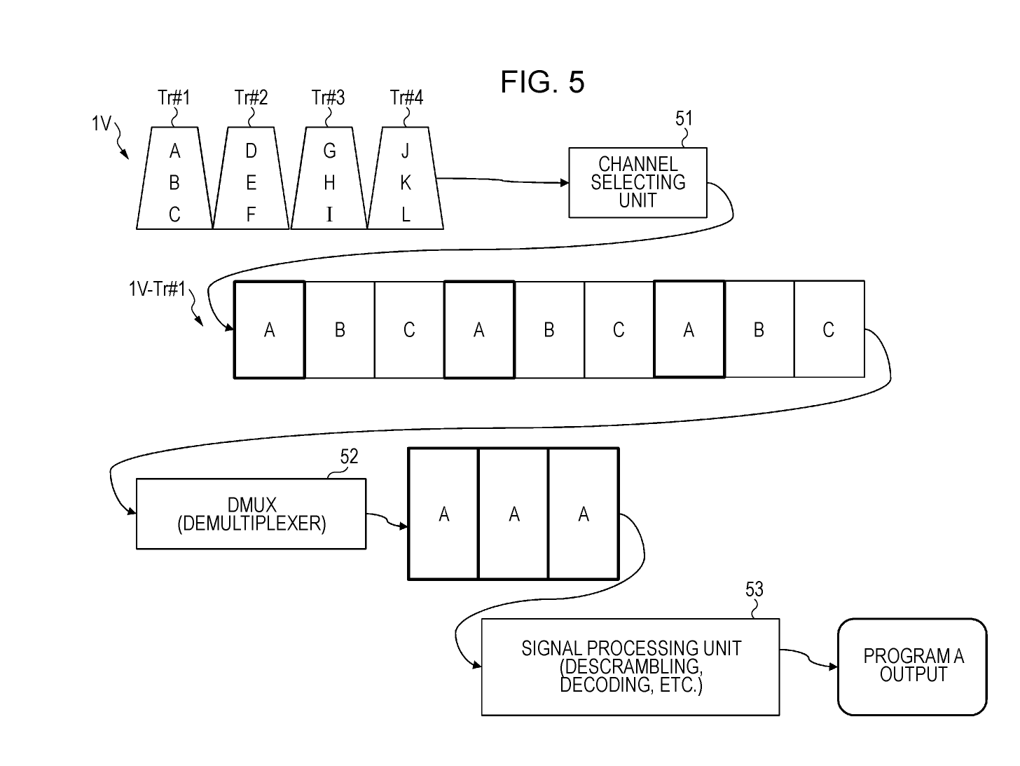

Referring now to FIG. 5, subsequent processes in the tuner 22 will be described.

FIG. 5 shows the processes to be performed when the user selects to view the “program A” via the input unit in the tuner 22. In this case, the tuner 22 outputs to the antenna a control signal for enabling the reception of the vertically polarized signal from the first satellite (1V) as shown in FIG. 3, and the antenna 21 receives only the vertically polarized signal from the first satellite (1V) and outputs this signal to the tuner 22.

The antenna inputs the vertically polarized signal from the first satellite (1V) to the tuner 22. As described above with reference to FIG. 2, this signal (1V) is configured of the following transponders:
transponder (Tr#1) including programs A-C,
transponder (Tr#2) including programs D-F,
transponder (Tr#3) including programs G-I,
and so on.

The channel selecting unit 51 in the tuner selects from these transponders a transponder including the program selected by the user. For example, when the transponders are configured of signals of different frequencies, the channel selecting unit 51 selects the transponder including the “program A” selected by the user on the basis of the frequencies.

In the example shown in FIG. 5, the transponder (Tr#1) including the “program A” selected by the user is selected.

The selected transponder (Tr#1) includes programs A-C.

The selected transponder (Tr#1) is input to the demultiplexer (DMUX) 52 in the tuner 22, where only the packets forming the “program A” selected by the user are selected.

Packets of a plurality of programs (contents) are mixed in the transponder and each of the packets is assigned a packet ID (PID). The demultiplexer (DMUX) 52 selects only the packets of the “program A” selected by the user on the basis of the packet ID assigned to each packet.

The selected packets of the program A are then input to the signal processing unit 53 in the tuner 22.

The signal processing unit 53 performs signal processing such as descrambling and decoding and generates and outputs image data and sound data of the “program A” that can be output to a display device. These output data are output through a display device such as a television screen and a loudspeaker, for example.

Heretofore, the typical satellite broadcast reception and output processes have been described.

As apparent from the above description, the antenna can receive a plurality of signals. In the example shown in FIG. 1, the antenna can receive the following four signals:
(1) vertically polarized signal from first satellite (1V),
(2) horizontally polarized signal from the first satellite (1H),
(3) vertically polarized signal from the second satellite (2V), and
(4) horizontally polarized signal from the second satellite (2H).

Of these signals, only one signal containing the program selected by the user can be output from the antenna to the tuner. This means that it is not able to view one program on a television screen and record another program being broadcast at the same time.

An exemplary configuration for solving this problem will now be described.

### [2. Satellite Broadcast Receiving Configuration Enabling the Reception of a Plurality of Programs]

A satellite broadcast receiving configuration enabling the reception of a plurality of programs will be described below.

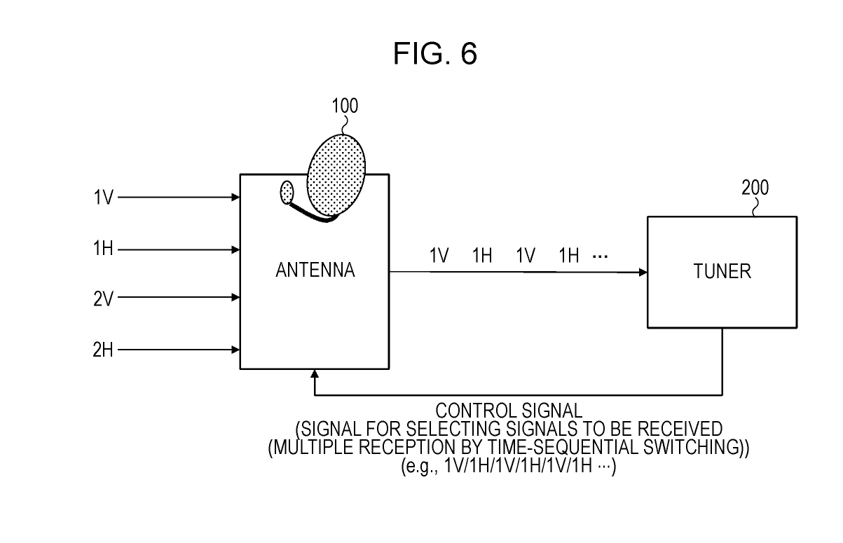

Referring now to FIG. 6 and following drawings, an exemplary configuration of a satellite receiver enabling the reception of a plurality of programs will be described.

Similarly to the typical satellite broadcast receiving system described above with reference to FIGS. 1 and 2, the configuration shown in FIG. 6 includes an antenna 100 and a tuner 200.

In the exemplary configuration described below, the antenna 100 can receive the following four signals from two satellites as in the configuration described above with reference to FIGS. 1 and 2:
(1) vertically polarized signal from the first satellite (1V),
(2) horizontally polarized signal from the first satellite (1H),
(3) vertically polarized signal from the second satellite (2V), and
(4) horizontally polarized signal from the second satellite (2H).

A difference from the configuration described above with reference to FIG. 3 is the control signals output from the tuner 200 to the antenna 100.

The tuner 200 shown in FIG. 6 outputs to the antenna 100 control signals enabling sequential reception of a plurality of signals of the above four signals ((1V), (1H), (2V), and (2H)).

For example, the tuner 200 time-sequentially changes and outputs control signals for enabling alternate reception of the following two signals as shown in FIG. 6:
(1) vertically polarized signal from the first satellite (1V) and
(2) horizontally polarized signal from the first satellite (1H).

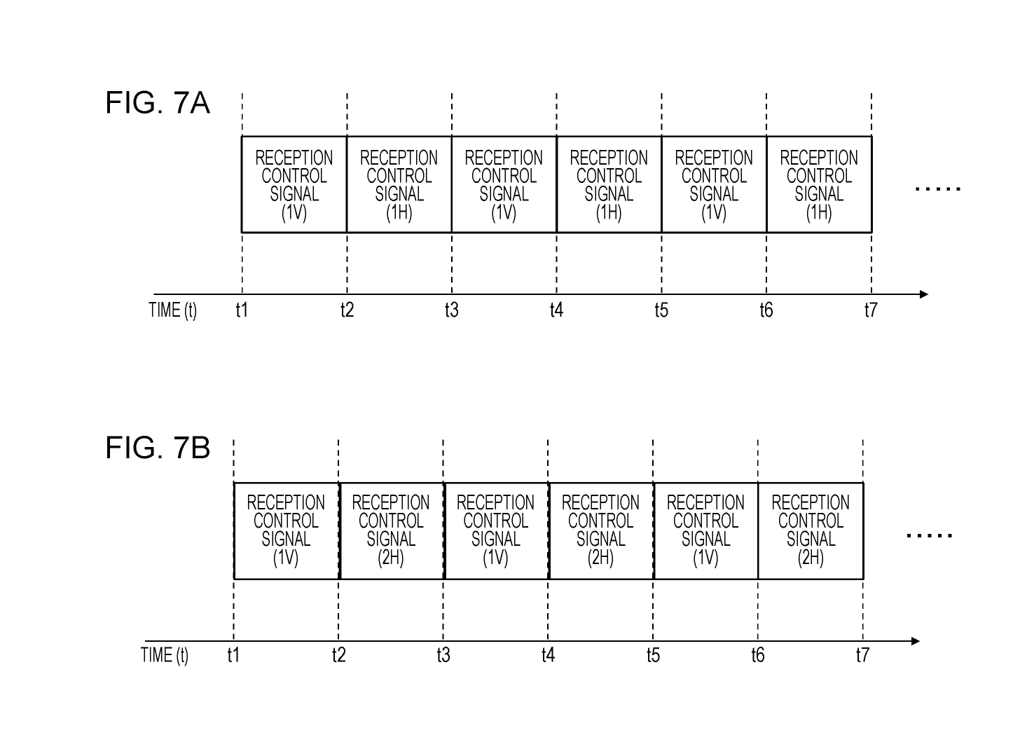

FIGS. 7A and 7B show specific examples of the control signals.

In FIGS. 7A and 7B, two exemplary control signals output from the tuner 200 to the antenna 100 are shown:
in FIG. 7A, control signals for alternate reception of the vertically polarized signal from the first satellite (1V) and the horizontally polarized signal from the first satellite (1H), and
in FIG. 7B, control signals for alternate reception of the vertically polarized signal from the first satellite (1V) and the horizontally polarized signal from the second satellite (2H).

For example, in the example shown in FIG. 7A, control signals for alternately changing the reception settings are output from the tuner 200 to the antenna 100:
time t1-t2: setting for receiving the vertically polarized signal from the first satellite (1V),
time t2-t3: setting for receiving the horizontally polarized signal from the first satellite (1H),
time t3-t4: setting for receiving the vertically polarized signal from the first satellite (1V),
time t4-t5: setting for receiving the horizontally polarized signal from the first satellite (1H), and so on.

In response to the input of the control signals for these settings, the antenna 100 alternately receives the following different broadcast signals on a time-division basis:
time t1-t2: reception of the vertically polarized signal from the first satellite (1V),
time t2-t3: reception of the horizontally polarized signal from the first satellite (1H),
time t3-t4: reception of the vertically polarized signal from the first satellite (1V),
time t4-t5: reception of the horizontally polarized signal from the first satellite (1H),
and so on.

In the example shown in FIG. 7B, control signals for alternately changing the reception settings are output from the tuner 200 to the antenna 100:
time t1-t2: setting for receiving the vertically polarized signal from the first satellite (1V),
time t2-t3: setting for receiving the horizontally polarized signal from the second satellite (2H),
time t3-t4: setting for receiving the vertically polarized signal from the first satellite (1V),
time t4-t5: setting for receiving the horizontally polarized signal from the second satellite (2H),
and so on.

In response to the input of the control signals for these settings, the antenna 100 alternately receives the following different broadcast signals on a time-division basis:
time t1-t2: reception of the vertically polarized signal from the first satellite (1V),
time t2-t3: reception of the horizontally polarized signal from the second satellite (2H),
time t3-t4: reception of the vertically polarized signal from the first satellite (1V),
time t4-t5: reception of the horizontally polarized signal from the second satellite (2H),
and so on.

In this manner, in response to the control signals input from the tuner 200, the antenna 100 alternately supplies the received broadcast waves to the tuner 200.

In the example shown in FIG. 6, a plurality of control signals for changing the settings are alternately output from the tuner 200. If the antenna 100 has a command interpreting function or the like, for example, the tuner 200 may output only predetermined control signal identification information so that a data processing unit in the antenna 100 interprets the identification information and alternately changes the reception settings.

Here, description will be given assuming that the tuner 200 alternately outputs the control signals for making the reception settings to receive different signals as shown in FIG. 6.

The antenna 100, in response to the control signals from the tuner 200, alternately switches between the reception settings to receive different signals.

Described below is an exemplary process in which control signals including information for alternate reception of the following two broadcast waves are used as shown in FIGS. 6 and 7A:
(1) vertically polarized signal from the first satellite (1V), and
(2) horizontally polarized signal from the first satellite (1H).

Under the control described above, the following two signals are alternately input to the tuner 200:
(1) vertically polarized signal from the first satellite (1V), and
(2) horizontally polarized signal from the first satellite (1H).

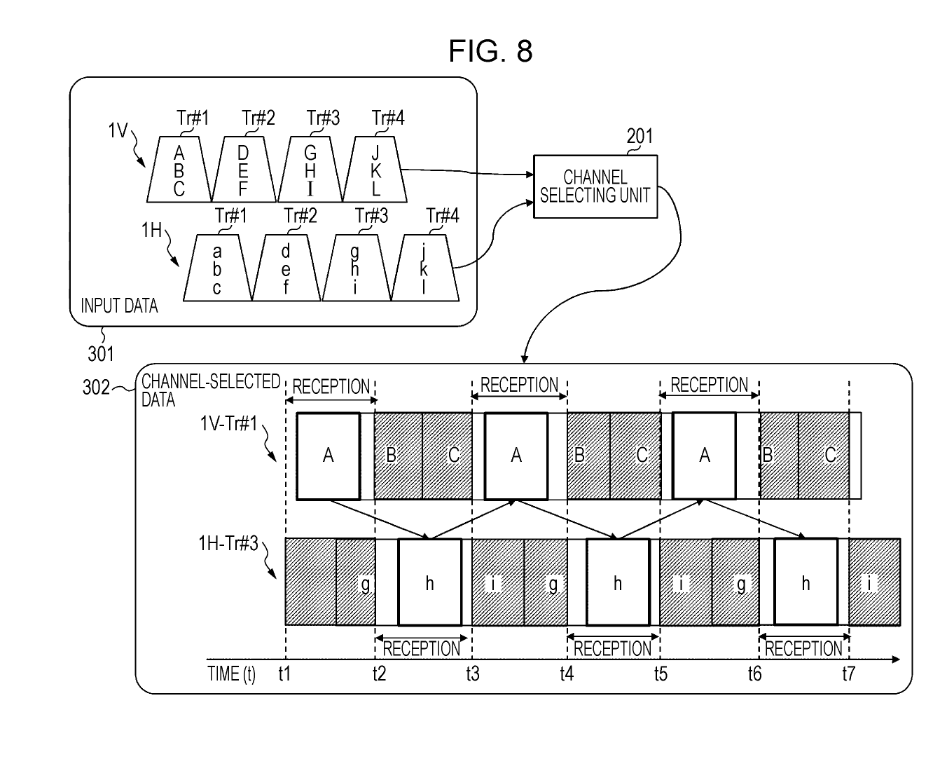

Processes in the tuner 200 to which these two signals are alternately input will be described with reference to FIG. 8 and following drawings.

FIG. 8 shows a process performed by the channel selecting unit 201 in the tuner 200.

The following two signals are alternately input from the antenna 100 to the tuner 200:
(1) vertically polarized signal from the first satellite (1V), and
(2) horizontally polarized signal from the first satellite (1H).

The input data 301 shown in FIG. 8 are input to the tuner 200.

The input data 301 shown in FIG. 8 show the following two signals in their entirety:
(1) vertically polarized signal from the first satellite (1V), and
(2) horizontally polarized signal from the first satellite (1H).

These signals (1V) and (1H) are not entirely input to the tuner 200, but the signals (1V) and (1H) are input in turn on a time-division basis to the tuner 200.

The channel selecting unit 201 selects transponders including specific two programs (channels) from the signals (1V) and (1H) input in turn on a time-division basis.

(1) As described above with reference to FIG. 2, the vertically polarized signal from the first satellite (1V) is configured of the following transponders:

transponder (Tr#1) including programs A-C,

transponder (Tr#2) including programs D-F,

transponder (Tr#3) including programs G-I,

and so on.

(2) The horizontally polarized signal from the first satellite (1H) is configured of the following transponders:

transponder (Tr#1) including programs a-c,

transponder (Tr#2) including programs d-f,

transponder (Tr#3) including programs g-i,

and so on.

From these transponders, the channel selecting unit 201 in the tuner 200 selects transponders including the programs selected by the user.

Here, description will be given assuming that the user selects a “program A” as the program to be displayed on a television screen and a “program h” as the program to be recorded.

On the basis of the selection information of the “program A” and “program h”, the channel selecting unit 201 selects these two programs from the transponders included in the received signals.

For example, when the transponders are configured of signals of different frequencies as described above, the channel selecting unit 201 selects the transponders including the “program A” and “program h” selected by the user on the basis of the frequencies of the transponders.

The transponder including the “program A” selected by the user is included in the vertically polarized signal from the first satellite (1V) (1V-Tr#1) and is selected during the reception periods allocated to the vertically polarized signal from the first satellite (1V).

The transponder including the “program h” selected by the user is included in the horizontally polarized signal from the first satellite (1H) (1H-Tr#3) and is selected during the reception periods allocated to the horizontally polarized signal from the first satellite (1H).

The channel-selected data 302 in FIG. 8 shows an exemplary process performed by the channel selecting unit 201 to select the two transponders included in the two broadcast signals:

(1) transponder (Tr#1) included in the vertically polarized signal from the first satellite (1V), and

(2) transponder (Tr#3) included in the horizontally polarized signal from the first satellite (1H).

The channel-selected data 302 in FIG. 8, where the horizontal axis indicates the time (t), shows the reception periods and non-reception periods in the periods (t1-t7) allocated to the two transponders included in the two broadcast waves.

Similarly to the reception periods shown in FIG. 7A, the reception periods allocated to each transponder are set as follows to alternately change the received signals:

t1-t2: reception period allocated to the transponder (Tr#1) included in the vertically polarized signal from the first satellite (1V),

t2-t3: reception period allocated to the transponder (Tr#3) included in the horizontally polarized signal from the first satellite (1H),

t3-t4: reception period allocated to the transponder (Tr#1) included in the vertically polarized signal from the first satellite (1V),

t4-t5: reception period allocated to the transponder (Tr#3) included in the horizontally polarized signal from the first satellite (1H),

and so on.

As shown in FIG. 8, the transponder (Tr#1) included in the vertically polarized signal from the first satellite (1V) includes programs A-C; while the transponder (Tr#3) included in the horizontally polarized signal from the first satellite (1H) includes programs g-i.

The program transmission sequence from each transponder is as follows:

The transponder (Tr#1) included in the vertically polarized signal from the first satellite (1V) sequentially transmits packets including the programs on a time-division basis in this order: A, B, C, A, B, C, A, B, and so on.

Similarly, the transponder (Tr#3) included in the horizontally polarized signal from the first satellite (1H) sequentially transmits packets including the programs on a time-division basis in this order: g, h, i, g, h, i, g, h, and so on.

Accordingly, the data (packets) corresponding to the following two programs can be received as shown in the channel-selected data 302 in FIG. 8:

“program A” during the reception periods allocated the vertically polarized signal from the first satellite (1V), and

“program h” during the reception periods allocated to the horizontally polarized signal from the first satellite (1H).

As shown in the channel-selected data 302 in FIG. 8, the channel selecting unit 201 selects the transponder (Tr#1) including the “program A” during the reception periods allocated to the vertically polarized signal from the first satellite (1V), and selects the transponder (Tr#3) including the “program h” during the reception periods allocated to the horizontally polarized signal from the first satellite (1H).

More specifically, the channel selecting unit 201 alternately selects the following transponders:

t1-t2: transponder (Tr#1) including the “program A” from the vertically polarized signal from the first satellite (1V),

t2-t3: transponder (Tr#3) including the “program h” from the horizontally polarized signal (1H) from the first satellite,

t3-t4: transponder (Tr#1) including the “program A” from the vertically polarized signal from the first satellite (1V),

t4-t5: transponder (Tr#3) including the “program h” from the horizontally polarized signal (1H) from the first satellite,

and so on.

The channel selecting unit 201 supplies to the demultiplexer (DMUX) 202 in the tuner 200 the transponders alternately selected from the two broadcast waves.

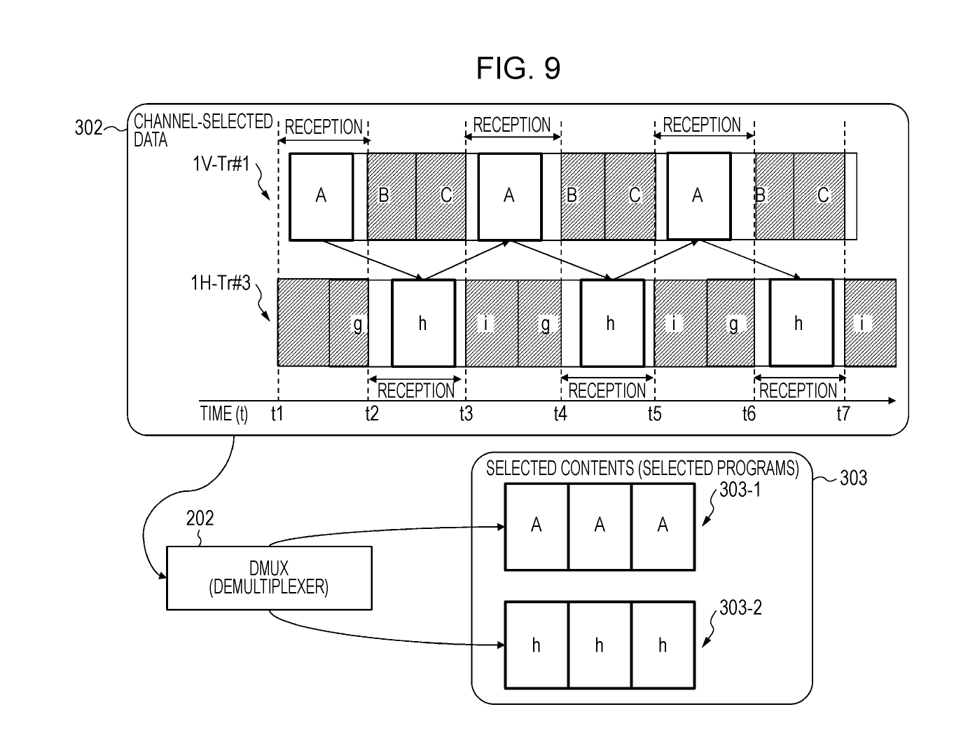

Referring now to FIG. 9, a process performed by the demultiplexer (DMUX) 202 in the tuner 200 will be described.

The demultiplexer (DMUX) 202 receives the channel-selected data 302 including the transponders selected by the channel selecting unit 201.

As described above with reference to FIG. 8, the channel-selected data 302 alternately includes the data supplied from these transponders:

transponder (Tr#1) including the “program A” included in the vertically polarized signal from the first satellite (1V), and

transponder (Tr#3) including the “program h” included in the horizontally polarized signal from the first satellite (1H).

The demultiplexer (DMUX) 202 selects from these transponders only the data (packets) of the “program A” and “program h” selected by the user.

The transponders received during each reception period includes packets of programs (contents) other than the “program A” and “program h” selected by the user, of which the demultiplexer (DMUX) 202 selects only the packets of the programs selected by the user on the basis of the packet IDs (PID) assigned to each packet.

More specifically, the demultiplexer (DMUX) 202 repeats a data selection process as follows:

t1-t2: selection of data (packet) of “program A” from the transponder (Tr#1) included in the vertically polarized signal from the first satellite (1V),

t2-t3: selection of data (packet) of “program h” from the transponder (Tr#3) included in the horizontally polarized signal from the first satellite (1H),

t3-t4: selection of data (packet) of “program A” from the transponder (Tr#1) included in the vertically polarized signal from the first satellite (1V),

t4-t5: selection of data (packet) of “program h” from the transponder (Tr#3) included in the horizontally polarized signal from the first satellite (1H),

and so on.

This selection process provides the selected contents (selected programs) 303 shown in FIG. 9.

As shown in FIG. 9, the selected contents 303 include two programs:

program A, 303-1, and

program h, 303-2.

The packets of these two programs are then input to the signal processing unit 203 in the tuner 200.

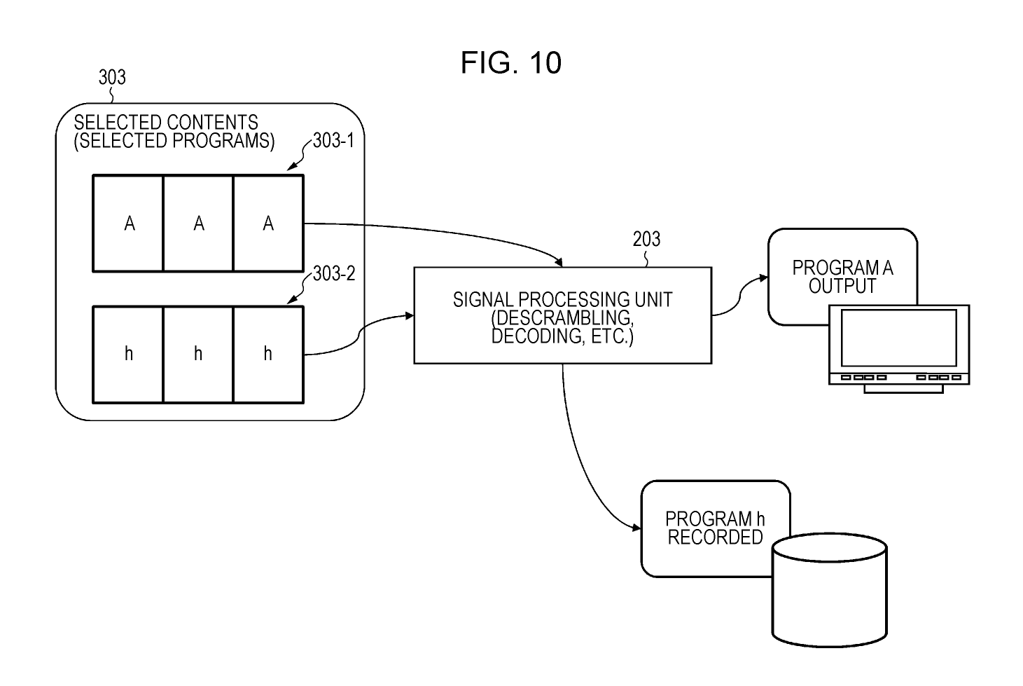

An exemplary process performed by the signal processing unit 203 is shown in FIG. 10.

The signal processing unit 203 shown in FIG. 10 performs signal processing such as descrambling and decoding, for example.

In this example, signal processing is performed on the data of these two programs:

program A, 303-1, and

program h, 303-2.

The content data subjected to the signal processing in the signal processing unit 203 is then output and displayed on a television screen or other display unit, or output and recorded in a hard disk or other recording device.

In the example shown in FIG. 10, the program A is output as the content to be displayed on a television screen, while the program h is output as the content to be recorded in a recording unit.

In this manner, it is possible to receive two programs by causing the antenna to receive a plurality of different broadcast waves on a time-division basis and output the received waves to the tuner so that the tuner extracts specific program data during the reception periods.

### [3. Exemplary Configuration of a Satellite Receiver]

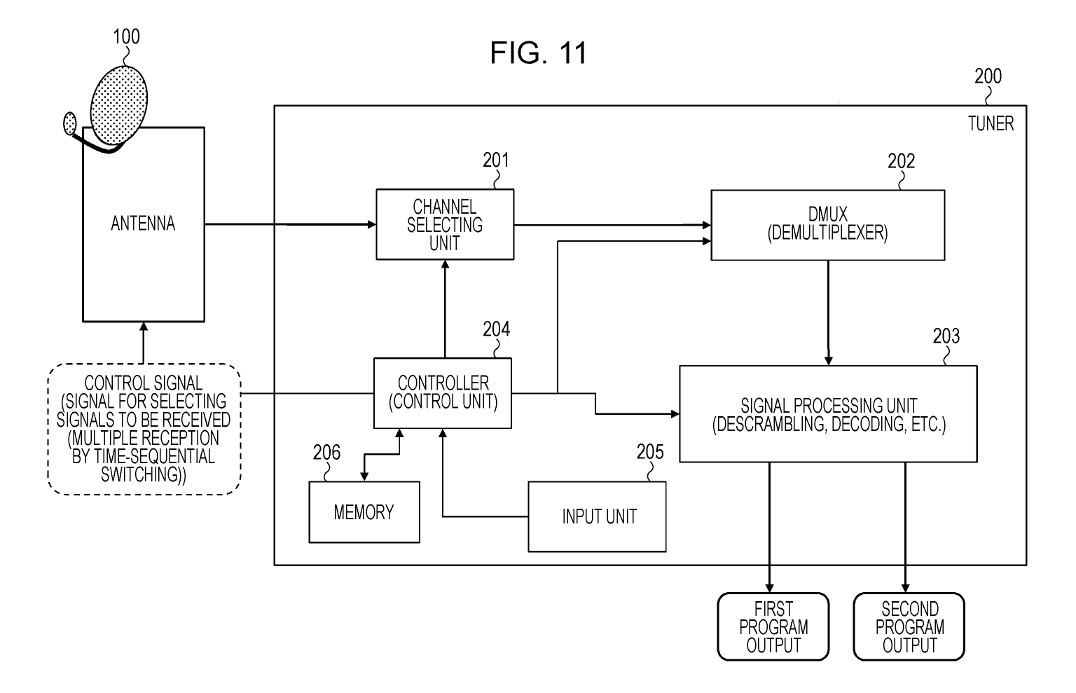

Referring now to FIG. 11, an exemplary configuration of a satellite receiver capable of receiving a plurality of programs described above will be described.

FIG. 11 shows a configuration including the antenna 100 and tuner 200 described above with reference to FIGS. 6 to 10.

The tuner 200 includes the channel selecting unit 201, demultiplexer (DMUX) 202, signal processing unit 203, controller (control unit) 204, input unit 205, and memory 206.

In response to the control signals output from the controller (control unit) 204 in the tuner 200, the antenna 100 time-sequentially receives a plurality of different broadcast waves in turn.

In response to a plurality of program selection information input by the user via the input unit 205, the controller (control unit) 204 outputs to the antenna 100 control signals for receiving the plurality of programs.

The channel selecting unit 201 performs the process described above with reference to FIG. 8.

More specifically, the channel selecting unit 201 selects transponders including the plurality of programs (channels) selected by the user from the plurality of broadcast signals input in turn on a time-division basis (e.g., any combination of (1V), (1H), (2V), (2H), and so on).

The demultiplexer (DMUX) 202 performs the process described above with reference to FIG. 9.

More specifically, the demultiplexer (DMUX) 202 receives the transponders selected by the channel selecting unit 201 and selects from the transponders only the data corresponding to the programs selected by the user.

For example, in the process described above with reference to FIG. 9, the demultiplexer (DMUX) 202 selects data of the two programs by performing the following process, for example, for each of the broadcast signal reception periods:

t1-t2: selection of data (packets) of “program A” from the transponder (Tr#1) included in the vertically polarized signal from the first satellite (1V), and

t2-t3: selection of data (packets) of “program h” from the transponder (Tr#3) included in the horizontally polarized signal from the first satellite (1H).

The signal processing unit 203 performs the process described above with reference to FIG. 10.

More specifically, the signal processing unit 203 performs signal processing such as descrambling and decoding, for example, on the program data input from the demultiplexer (DMUX) 202.

The memory 206 is used as the space for recording the programs to be executed by the controller (control unit) 204 and the data necessary for data processing and as the space for storing information of the settings of control signals.

### [4. Exemplary Broadcast Signals Having Synchronizing Signals]

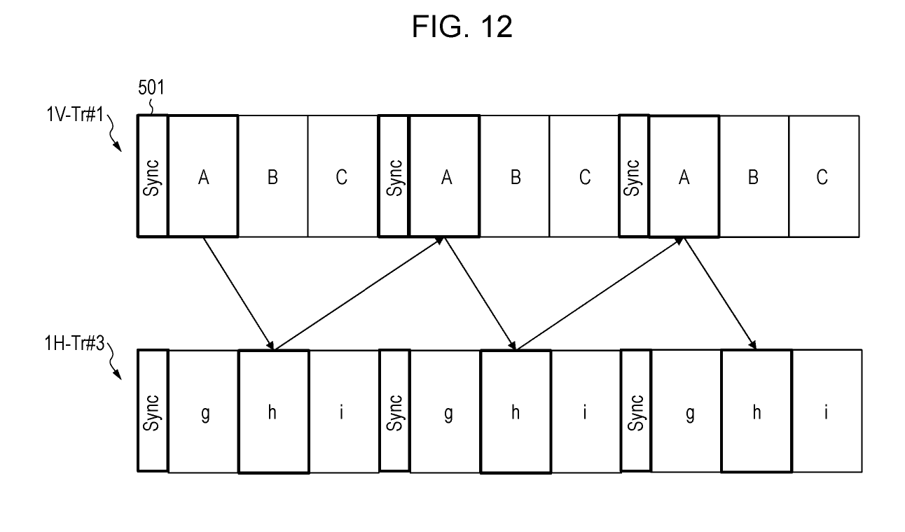

Referring now to FIG. 12, exemplary broadcast signals having synchronizing signals will be described.

As described above, when a plurality of broadcast signals are received in turn, each broadcast signal encounters reception periods and non-reception periods.

In the exemplary processes described above with reference to FIG. 8 and other drawings, the reception periods are set such that the “program A” and “program h” selected by the user can be received in the reception periods.

The program sequence in the broadcast signal transmitted from a broadcasting station may sometimes be changed. This could make it difficult to make control to ensure the reception of necessary programs during the reception periods unless information of this changed program sequence is provided.

In such a case, broadcast signals having synchronizing signals 501 shown in FIG. 12 are used.

For example, the following settings information (program sequence information) including the synchronizing signals 501 is received in advance from the broadcasting station and stored in the memory in the tuner:

period ta-tb: program x,

period tb-tc: program y, and

period tc-td: program z.

On the basis of this settings information (program sequence information), the controller (control unit) in the tuner generates and outputs to the antenna control signals in which the reception periods and non-reception periods allocated to each broadcast signal are set.

This control allows the program data of the programs selected by the user to be received securely during the reception periods.

Note that the broadcasting station may be configured such that it can generate a list of parallel-receivable programs from the information of the programs to be transmitted therefrom and provide this list to the receiver at the user end such that the list can be displayed together with the program listing to allow the viewer to identify the parallel-receivable programs and the parallel-unreceivable programs.

For example, when the program to be viewed is the program A in the broadcast signal shown in FIG. 12, the programs h and i to be recorded, for example, can be received together with the program A because their reception periods do not overlap the reception periods of the program A, while the program g is not received in parallel with the program A because the reception periods of the program g overlap the reception periods of the program A.

Providing to the user (viewer) information of parallel-receivable program combinations or information of parallel-unreceivable program combinations will allow the viewer to select securely receivable program combinations.

### [5. Overview of Embodiments of the Present Disclosure]

Some embodiments of the present disclosure have been described with reference to the specific embodiments. It is obvious to those skilled in the art that modifications and substitutions may be made to these embodiments without departing from the spirit and scope of the present disclosure. This means that the present technology has been disclosed by way of example only and should not be interpreted limitatively. The spirit and scope of the present disclosure should be judged according to the embodiments of the present disclosure.

The technology disclosed in this specification can adopt the following configurations:

(1) a satellite receiver including a control unit adapted to output to an antenna control signals for time-sequentially switching between a plurality of different satellite broadcast signals, a channel selecting unit adapted to select a transponder including a specific program from each of a plurality of broadcast signals input from the antenna, and a demultiplexer adapted to extract specific program data from each of the transponders selected by the channel selecting unit.

(2) The satellite receiver according to item (1), wherein the control unit, in response to a plurality of program selection information input via an input unit, outputs to the antenna control signals for enabling reception of the selected programs.

(3) The satellite receiver according to item (1) or (2), wherein the control unit outputs to the antenna at least one of a control signal for switching between satellite broadcast signals coming from a plurality of different satellites and a control signal for switching between a vertically polarized signal and a horizontally polarized signal coming from a same satellite.

(4) The satellite receiver according to any one of items (1)-(3), wherein the channel selecting unit selects a transponder including the specific program during each reception period allocated to each of the plurality of broadcast signals input from the antenna, selects a first transponder including a first program from the signal being received during the reception periods allocated to the first broadcast signal, and selects a second transponder including a second program from the signal being received during the reception periods allocated to the second broadcast signal.

(5) The satellite receiver according to any one of items (1)-(4), wherein the demultiplexer extracts specific data including the first program from the first transponder selected by the channel selecting unit from the signal being received during the reception periods allocated to the first broadcast signal, and extracts specific data including the second program from the second transponder selected by the channel selecting unit from the signal being received during the reception periods allocated to the second broadcast signal.

(6) The satellite receiver according to any one of items (1)-(5), further including a signal processing unit adapted to perform signal processing on the program data extracted by the demultiplexer.

(7) The satellite receiver according to any one of items (1)-(6), wherein the control unit, on the basis of synchronizing signals set in the broadcast signals, generates and outputs to the antenna control signals in which reception periods allocated to each broadcast signal are set.

The processing sequence described in this specification may be implemented by hardware, software, or a combination thereof. When the processing is implemented by software, a program with a processing sequence recorded therein can be installed and executed in the memory in a computer built in a dedicated hardware, or in a general-purpose computer capable of executing various types of processing. For example, the program can be recorded in a recording medium in advance. Instead of being installed from the recording medium to the computer, the program may be received through a network such as a LAN (local area network) or the Internet and installed in a recording medium such as a built-in hard disk.

Note that the various processes described in this specification may be executed sequentially in the order of description, or may be executed in parallel or individually as necessary or depending on the processing capacity of the devices that perform these processes. In this specification, the system is a logical aggregate configuration of a plurality of devices that are not necessarily accommodated in the same housing.

What is claimed is:

1. A satellite receiver comprising:
a control unit adapted to output to an antenna control signals for time-sequentially switching between a plurality of different satellite broadcast signals;
a channel selecting unit adapted to select a transponder including a specific program from each of a plurality of broadcast signals input from the antenna; and
a demultiplexer adapted to extract specific program data from each of the plurality of transponders selected by the channel selecting unit.

2. The satellite receiver according to claim 1,
wherein the control unit, in response to a plurality of program selection information input via an input unit, outputs to the antenna control signals for enabling reception of the plurality of selected programs.

3. The satellite receiver according to claim 1,
wherein the control unit outputs to the antenna at least one of a control signal for switching between satellite broadcast signals coming from a plurality of different satellites and a control signal for switching between a vertically polarized signal and a horizontally polarized signal coming from a same satellite.

4. The satellite receiver according to claim 1,
wherein the channel selecting unit selects a transponder including a specific program during reception periods allocated to each of a plurality of broadcast signals input from the antenna, selects a first transponder including a first program from a signal being received during the reception periods allocated to a first broadcast signal, and selects a second transponder including a second program from a signal being received during the reception periods allocated to a second broadcast signal.

5. The satellite receiver according to claim 1,
wherein the demultiplexer extracts data including a first program from a first transponder selected by the channel selecting unit from a signal being received during reception periods allocated to a first broadcast signal, and extracts data including a second program from a second transponder selected by the channel selecting unit from a signal received during reception periods allocated to a second broadcast signal.

6. The satellite receiver according to claim 1, further comprising:
a signal processing unit adapted to perform signal processing on the program data extracted by the demultiplexer.

7. The satellite receiver according to claim 1,
wherein the control unit, on the basis of synchronizing signals set in the broadcast signals, generates and outputs to the antenna control signals including reception period settings for each broadcast signal.

8. A satellite broadcast receiving method executed by a satellite receiver, the method comprising:
outputting from a control unit to an antenna a control signal for time-sequentially switching between a plurality of different satellite broadcast signals;
selecting in a channel selecting unit a transponder including a specific program from each of a plurality of broadcast signals input from the antenna; and
extracting in a demultiplexer specific program data from each of the plurality of transponders selected by the channel selecting unit.

9. A program for executing a satellite broadcast receiving process in a satellite receiver, the program comprising:
causing a control unit to output to an antenna control signals for time-sequentially switching between a plurality of different satellite broadcast signals;
causing a channel selecting unit to select a transponder including a specific program from each of a plurality of broadcast signals input from the antenna; and
causing a demultiplexer to extract a specific program data from each of the plurality of transponders selected by the channel selecting unit.
